(19) United States
(12) Patent Application Publication
(10) Pub. No.: US 2015/0042858 A1
(43) Pub. Date: Feb. 12, 2015

(54) SOLID-STATE IMAGING DEVICE

(71) Applicant: KABUSHIKI KAISHA TOSHIBA, Tokyo (JP)

(72) Inventors: Koichi KOKUBUN, Yokohama-shi (JP); Takashi SATO, Fujisawa-shi (JP)

(73) Assignee: KABUSHIKI KAISHA TOSHIBA, Tokyo (JP)

(21) Appl. No.: 14/102,448

(22) Filed: Dec. 10, 2013

(30) Foreign Application Priority Data
Aug. 12, 2013 (JP) 2013-167735

(51) Int. Cl. H04N 5/369

(52) U.S. Cl. CPC H04N 5/3696
USPC 348/302

(57) ABSTRACT

According to one embodiment, there is provided a solid-state imaging device including a pixel array. In the pixel array, a plurality of pixels are arrayed. The plurality of pixels include an imaging pixel and a focus-detecting pixel. The focus-detecting pixel includes a first photoelectric conversion part, a first diffraction grating, and a second diffraction grating. The first diffraction grating is arranged above the first photoelectric conversion part. The second diffraction grating is arranged between the first photoelectric conversion part and the first diffraction grating.

### CROSS-REFERENCE TO RELATED APPLICATIONS

This application is based upon and claims the benefit of priority from Japanese Patent Application No. 2013-167735, filed on Aug. 12, 2013; the entire contents of which are incorporated herein by reference.

### FIELD

Embodiments described herein relate generally to a solid-state imaging device.

### BACKGROUND

For camera systems including a solid-state imaging device, there are two types of auto focus (AF) functions: a phase difference detection method and a contrast detection method. As the accuracy of the AF function, the phase difference detection method has an advantage of easy correction of a focus deviation at high speed, and the contrast detection method has an advantage of high focus accuracy of an image. However, the phase difference detection method has a disadvantage in terms of downsizing because it requires a separate sensor, and the contrast detection method has a disadvantage of taking a time to conduct focus correction because it searches for a focal position using an image of a photographing lens at each position. Therefore, in the camera systems, it is desired to realize downsizing of the camera system and a high-speed AF operation.

### BRIEF DESCRIPTION OF THE DRAWINGS

FIG. 1 is a diagram illustrating a configuration of a camera system to which a solid-state imaging device according to an embodiment is applied;

FIG. 2 is a diagram illustrating a configuration of the camera system to which the solid-state imaging device according to the embodiment is applied;

FIG. 3 is a diagram illustrating a circuit configuration of the solid-state imaging device according to the embodiment;

FIG. 4 is a diagram illustrating a cross-section configuration of the solid-state imaging device according to the embodiment;

FIG. 5 is a diagram illustrating a cross-section configuration of the solid-state imaging device according to the embodiment;

FIG. 6 is a diagram illustrating relationships between a focus state of a photographing lens and an incident angle of light to the solid-state imaging device in the embodiment;

FIG. 7 is a diagram illustrating an operation of a focus-detecting pixel in the embodiment;

FIG. 8 is a diagram illustrating a layout configuration of a pixel array in the embodiment;

FIG. 9 is a diagram illustrating a configuration of a focus-detecting pixel group in the embodiment;

FIG. 10 is a diagram illustrating cross-section configurations of two focus-detecting pixels arranged on opposite sides to each other with respect to a center of the pixel array in the embodiment;

FIG. 11 is a diagram illustrating a layout configuration of a pixel array in a modification of the embodiment;

FIG. 12 is a diagram illustrating a layout configuration of a pixel array in a modification of the embodiment;

FIG. 13 is a diagram illustrating cross-section configurations of two focus-detecting pixels respectively arranged in a central region and in a peripheral region in the modification of the embodiment;

FIG. 14 is a diagram illustrating a layout configuration of a pixel array in a modification of the embodiment; and

FIG. 15 is a diagram illustrating a layout configuration of a pixel array in a modification of the embodiment.

### DETAILED DESCRIPTION

In general, according to one embodiment, there is provided a solid-state imaging device including a pixel array. In the pixel array, a plurality of pixels are arrayed. The plurality of pixels include an imaging pixel and a focus-detecting pixel. The focus-detecting pixel includes a first photoelectric conversion part, a first diffraction grating, and a second diffraction grating. The first diffraction grating is arranged above the first photoelectric conversion part. The second diffraction grating is arranged between the first photoelectric conversion part and the first diffraction grating.

Exemplary embodiments of a solid-state imaging device will be explained below in detail with reference to the accompanying drawings. The present invention is not limited to the following embodiments.

### Embodiment

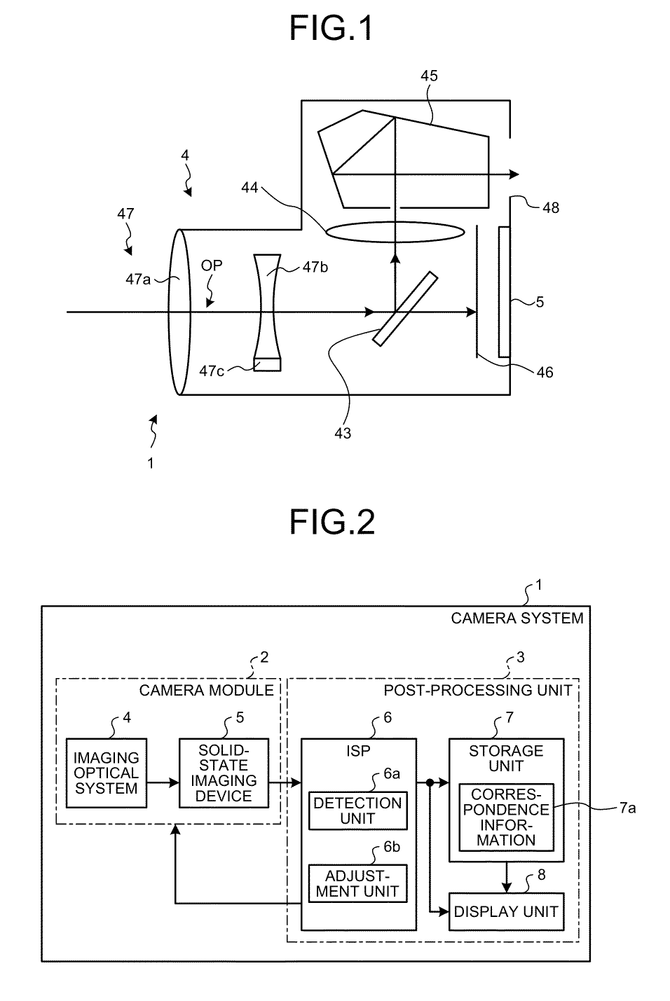

A solid-state imaging device according to an embodiment will be described. The solid-state imaging device is applied to an imaging system illustrated in FIGS. 1 and 2, for example. FIGS. 1 and 2 are diagrams illustrating schematic configurations of a camera system 1 as an example of the imaging system.

The camera system 1 may be, for example, a digital camera or a digital video camera, or may be an electronic device to which a camera module is applied (for example, a mobile terminal with camera, or the like). The camera system 1 includes, as illustrated in FIG. 2, a camera module 2 and a post-processing unit 3. The camera module 2 includes an imaging optical system 4 and a solid-state imaging device 5. The post-processing unit 3 includes an image signal processor (ISP) 6, a storage unit 7, and a display unit 8.

The imaging optical system 4 includes a photographing lens 47, a half mirror 43, a mechanical shutter 46, a lens 44, a prism 45, and a finder 48. The photographing lens 47 includes photographing lenses 47a and 47b, an aperture (not illustrated), and a lens drive mechanism 47c. The aperture is arranged between the photographing lens 47a and the photographing lens 47b, and adjusts the quantity of light lead to the photographing lens 47b. Note that, in FIG. 1, a case in which the photographing lens 47 includes the two photographing lenses 47a and 47b is exemplarily illustrated. However, the photographing lens 47 may include a number of photographing lenses.

The solid-state imaging device 5 is arranged on a scheduled image-forming surface of the photographing lens 47. For example, the photographing lens 47 refracts and leads incident light to an imaging surface of the solid-state imaging device 5 through the half mirror 43 and the mechanical shutter 46, and forms an image of an object on an imaging surface (pixel array 12) of the solid-state imaging device 5. The solid-state imaging device 5 generates an image signal according to the object image.

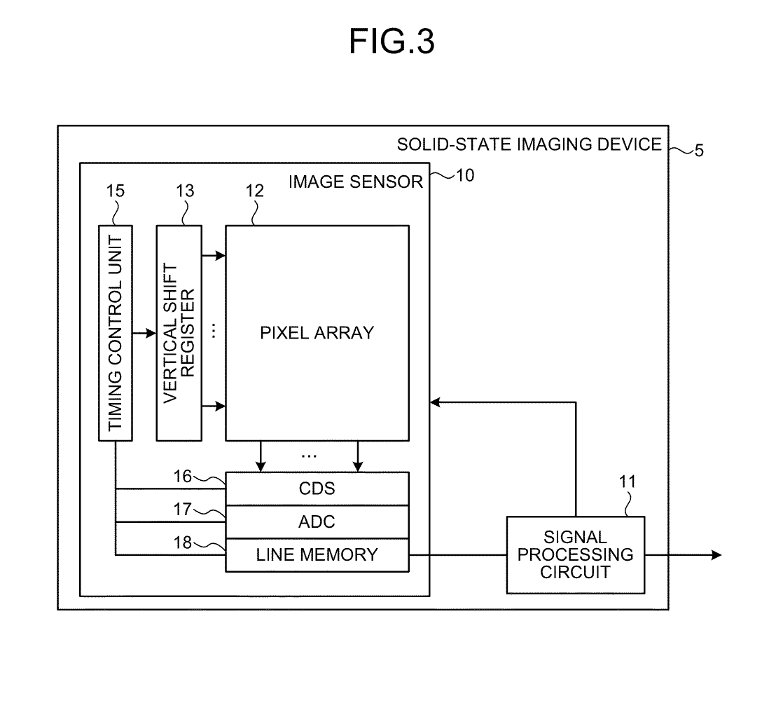

The solid-state imaging device 5 includes, as illustrated in FIG. 3, an image sensor 10 and a signal processing circuit 11. FIG. 3 is a diagram illustrating a circuit configuration of the solid-state imaging device. The image sensor 10 may be, for example, a CMOS image sensor or a CCD image sensor. The image sensor 10 includes the pixel array 12, a vertical shift register 13, a timing control unit 15, a correlated double sampling unit (CDS) 16, an analog-digital conversion unit (ADC) 17, and a line memory 18.

In the pixel array 12, a plurality of pixels are arranged in a two-dimensional manner. Each pixel includes a photoelectric conversion part (for example, a photodiode). The pixel array 12 generates an image signal according to the quantity of incident light to each pixel. The generated image signal is read out to the CDS 16 side by the timing control unit 15 and the vertical shift register 13, and the signal is converted into image data through the CDS 16/ADC 17, and is output to the signal processing circuit 11 through the line memory 18. The signal processing circuit 11 performs signal processing. The image data subjected to the signal processing is output from the signal processing circuit 11 to the ISP 6.

The lens drive mechanism 47c illustrated in FIG. 1 drives the photographing lens 47b along an optical axis OP under control of the ISP 6 (see FIG. 2). For example, the ISP 6 obtains focus adjustment information according to the AF (Auto Focus) function, controls the lens drive mechanism 47c based on the focus adjustment information, and adjusts the photographing lenses 47a and 47b to focusing states (just focus).

Assume a case of employing the phase difference detection method as the AF function in the camera system 1. In the phase difference detection method, a phase difference between a pair of image signals that have passed through different pupil regions in the photographing lens, obtains a direction and an amount of out of focus (defocusing amount) based on the phase difference, and drives the photographing lens to cancel the defocusing amount. Therefore, the phase difference detection method has an advantage of easy correction of a focus deviation at high speed.

However, in the phase difference detection method, the pair of image signals that have passed through the different pupil regions in the photographing lens is received. Therefore, it is necessary to additionally provide a pair of line sensors in the camera system 1, and also to add a half mirror that leads light to the pair of line sensors and a pair of separator lenses that form an image of the light on the pair of line sensors again as an object image. Therefore, there is a possibility that the camera system 1 is increased in size.

Alternatively, assume a case of employing the contrast detection method as the AF function in the camera system 1. In the contrast detection method, an object is imaged in the solid-state imaging device 5 while the photographing lens is driven, and a position where a contrast of the imaged image becomes highest is a focus position of the photographing lens. Therefore, the contrast detection method has an advantage of high focusing accuracy of an image.

However, in the contrast detection method, it is necessary to sequentially perform processing of obtaining an image of the object in each position of the photographing lens, calculating a contrast of the obtained image, and comparing the calculated contrast and a contrast of the image calculated in the past. In addition, it is necessary to drive the photographing lens in a reciprocating manner near front and rear parts of the position where the contrast becomes highest. Therefore, there is a disadvantage of requiring a time to perform focus correction to drive the photographing lens to the focus position.

Therefore, in the present embodiment, as a new method for realizing the AF function, a method to detect an incident angle of light using the Talbot effect, to obtain a defocusing amount based on the detected incident angle, and to perform focus correction. In the present embodiment, this method is called a Talbot method. That is, the solid-state imaging device 5 has a configuration suitable for the Talbot method (that is, a focus-detecting pixel), and the ISP 6 performs an AF operation according to the Talbot method. With the configuration, realizing both of downsizing of the camera system 1 and a high-speed AF operation are sought.

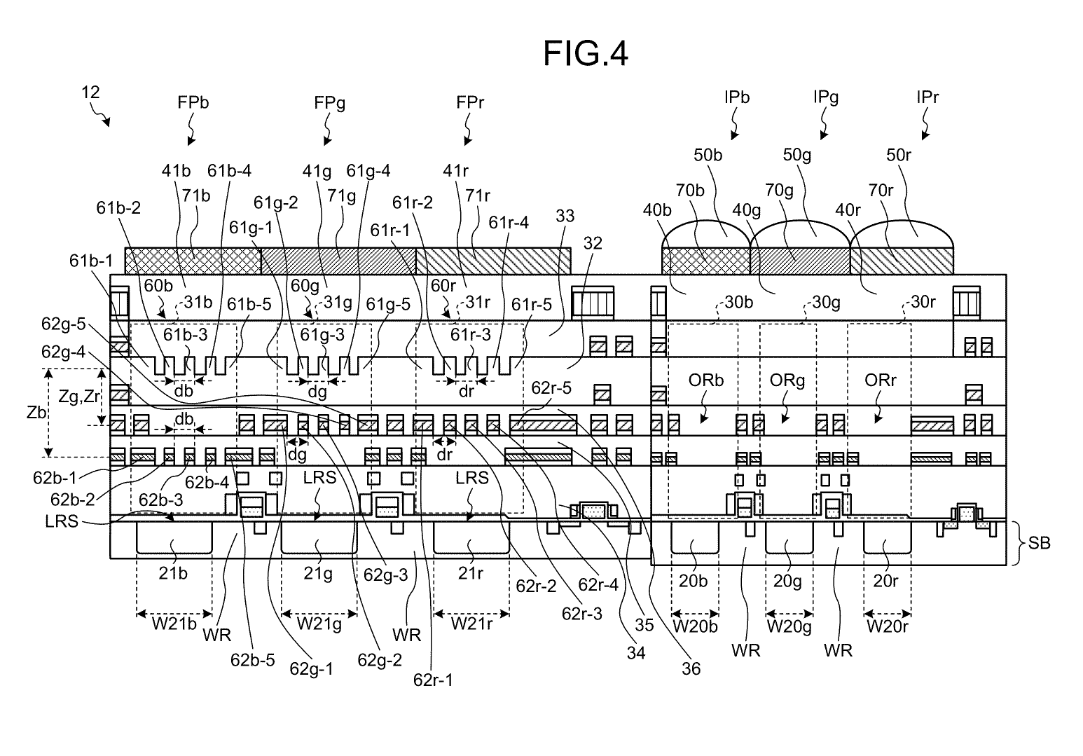

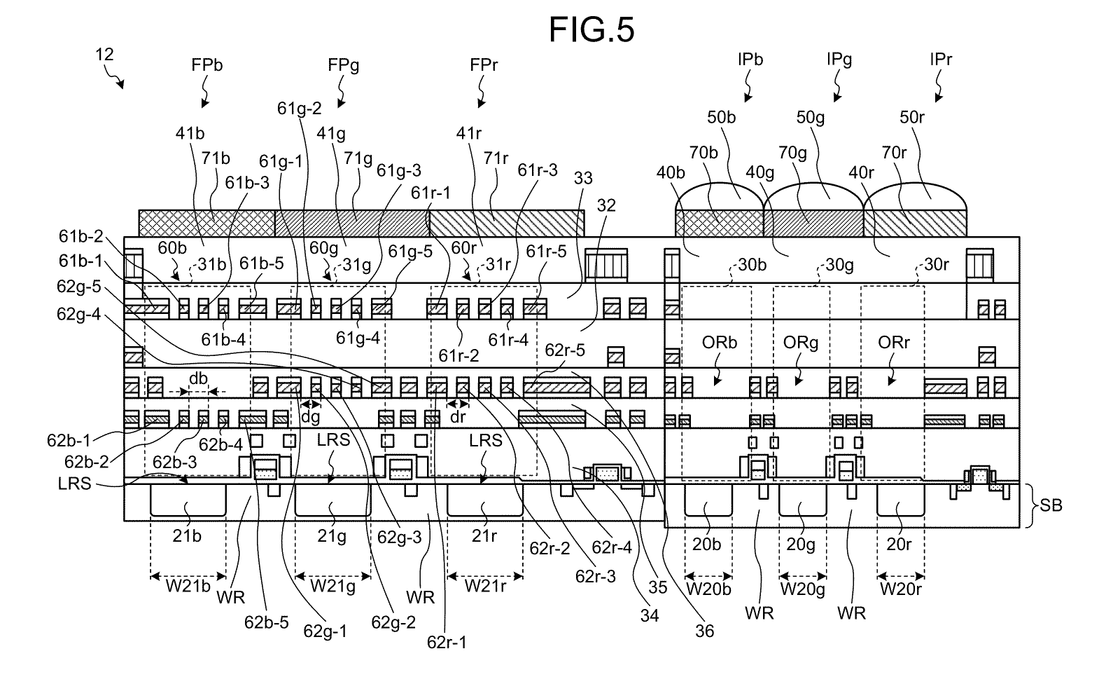

To be specific, the pixel array 12 of the solid-state imaging device 5 includes a plurality of imaging pixels IPr, IPg, and IPb and a plurality of focus-detecting pixels FPr, FPg, and FPb, as illustrated in FIGS. 4 and 5. FIGS. 4 and 5 exemplarily illustrate cross-section configurations of the solid-state imaging device 5 regarding three pixels of the plurality of imaging pixels IPr, IPg, and IPb and three pixels of the plurality of focus-detecting pixels FPr, FPg, and FPb.

The imaging pixels IPr, IPg, and IPb are pixels used for imaging the object image. The imaging pixels IPr, IPg, and IPb respectively include photoelectric conversion parts 20r, 20g, and 20b, multilayer wiring structures 30r, 30g, and 30b, flattening layers 40r, 40g, and 40b, color filters 70r, 70g, and 70b, and micro lenses 50r, 50g, and 50b.

The photoelectric conversion parts 20r, 20g, and 20b are arranged in a well region WR in a semiconductor substrate SB. The photoelectric conversion parts 20r, 20g, and 20b respectively receive light in red (R), green (G), and blue (B) wavelength regions. The photoelectric conversion parts 20r, 20g, and 20b respectively generate and store electric charges according to the received light. The photoelectric conversion parts 20r, 20g, and 20b are, for example, photodiodes and include charge storage regions.

The well region WR is formed of a semiconductor (for example, silicon) including first conductive type (for example, P type) impurities in low concentration. The P type impurities are, for example, boron. The charge storage regions of the photoelectric conversion parts 20r, 20g, and 20b are respectively formed of semiconductors (for example, silicon) including second conductive type (for example, N type) impurities, which are an opposite conductive type of the first conductive type, in higher concentration than the first conductive type impurities in the well region WR. The N type impurities are, for example, phosphorus or arsenic.

The multilayer wiring structures 30r, 30g, and 30b are arranged on the semiconductor substrate SB. A plurality of layers of wiring patterns extend in interlayer insulation films in the multilayer wiring structures 30r, 30g, and 30b. This enables the multilayer wiring structures 30r, 30g, and 30b to define opening regions ORr, ORg, and ORb corresponding to the photoelectric conversion parts 20r, 20g, and 20b, respectively. The interlayer insulation film is formed of silicon oxide, for example. The wiring patterns are formed of metal, for example.

The flattening layers 40r, 40g, and 40b respectively cover the multilayer wiring structures 30r, 30g, and 30b. This enables the flattening layers 40r, 40g, and 40b to reduce differences in level among the multilayer wiring structures 30r, 30g, and 30b and to provide a flat surface. The flattening layers 40r, 40g, and 40b are formed of predetermined resin or an oxide film (for example, SiO₂).

The color filters 70r, 70g, and 70b are arranged on the flattening layers 40r, 40g, and 40b above the photoelectric conversion parts 20r, 20g, and 20b. This enables the color filters 70r, 70g, and 70b selectively lead the light in the red (R), green (G), and blue (B) wavelength regions from among the incident light to the photoelectric conversion parts 20r, 20g, and 20b, respectively.

The micro lens 50r, 50g, and 50b are respectively arranged on the color filters 70r, 70g, and 70b. This enables the micro lens 50r, 50g, and 50b to concentrate the incident light to the photoelectric conversion parts 20r, 20g, and 20b through the color filters 70r, 70g, and 70b. The micro lens 50r, 50g, and 50b are formed of predetermined resin, for example.

The focus-detecting pixels FPr, FPg, and FPb are pixels for detecting the focusing states of the photographing lenses 47a and 47b (see FIG. 1), and output signals for detecting the focusing states of the photographing lenses 47a and 47b. The focus-detecting pixels FPr, FPg, and FPb include the photoelectric conversion parts 21r, 21g, and 21b, the multilayer wiring structures 31r, 31g, and 31b, the flattening layers 41r, 41g, and 41b, and the color filters 71r, 71g, and 71b. The focus-detecting pixel FPr, FPg, and FPb have structures basically similar to the structures of the imaging pixels IPr, IPg, and IPb. However, the focus-detecting pixels FPr, FPg, and FPb are different from the imaging pixels IPr, IPg, and IPb in the following points.

The multilayer wiring structures 31r, 31g, and 31b include angle detection structures 60r, 60g, and 60b. The angle detection structures 60r, 60g, and 60b detect incident angles of light incident on the focus-detecting pixels FPr, FPg, and FPb using the Talbot effect. The Talbot effect is one of diffraction phenomena of light, and refers to a phenomenon in which a pattern similar to a diffraction grating is periodically reproduced in units of certain depth at incidence of light (self-imaging effect). A Talbot distance Z_{T} is expressed by the following numerical expression 1 where the pitch of the diffraction grating is ‘d’ and the wavelength of the light is λ.

Z_{T}=2d²/λ Numerical Expression 1

According to the Talbot effect, a self-image of the diffraction grating appears at a position that is an even-number multiple of Z_{T}/2, and a self-image shifted by a half period with respect to the self-image appears at a position that is an odd-number multiple of Z_{T}/2, based on Z_{T}/2 that is the half of the Talbot distance. To detect the incident angle of light, both of the self-images can be used. In the present embodiment, a case to detect the incident angle of light using the self-image appearing at the position that is the odd-number multiple of Z_{T}/2 will be exemplarily described.

To be specific, the angle detection structure 60r includes first diffraction grating 61r-1 to 61r-5 and second diffraction grating 62r-1 to 62r-5.

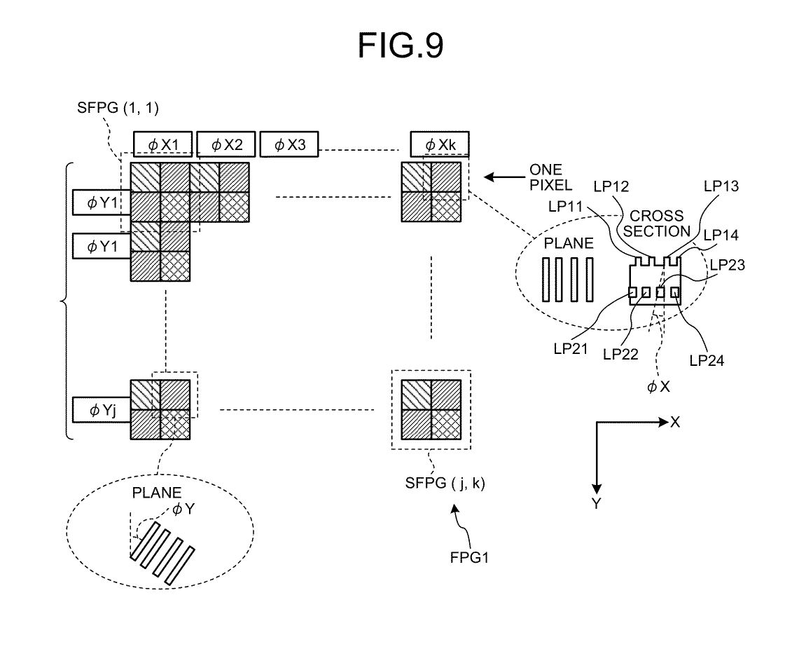

The first diffraction grating 61r-1 to 61r-5 is arranged above the photoelectric conversion part 21r. The first diffraction grating 61r-1 to 61r-5 is arranged between the photoelectric conversion part 21r and the color filter 71r, and is at least periodically arranged in a one-dimensional manner. For example, the first diffraction grating 61r-1 to 61r-5 includes a plurality of line patterns, and the plurality of line patterns are periodically arranged in a one-dimensional manner (see FIG. 9). The plurality of line patterns are periodically arranged in a short direction at a pitch ‘dr’, for example.

A plurality of grooves corresponding to the first diffraction grating 61r-1 to 61r-5 are formed in an upper surface of an uppermost interlayer insulation film (for example, a silicon oxide film) 32 in the multilayer wiring structure 31r, and a protection film (e.g., a silicon nitride film) 33 is embedded in the plurality of grooves, thereby to form the phase grating-type first diffraction grating 61r-1 to 61r-5. Note that, as illustrated in FIG. 5, the first diffraction grating 61r-1 to 61r-5 can be formed as amplitude grating-type diffraction grating by patterning of the uppermost wiring layer in the multilayer wiring structure 31r (e.g., into a plurality of line patterns).

The second diffraction grating 62r-1 to 62r-5 is arranged between the photoelectric conversion part 21r and the first diffraction grating 61r-1 to 61r-5. The second diffraction grating 62r-1 to 62r-5 has a pattern corresponding to the first diffraction grating 61r-1 to 61r-5. For example, the second diffraction grating 62r-1 to 62r-5 has a plurality of line patterns, and the plurality of line patterns are periodically arranged in a one-dimensional manner (see FIG. 9). The plurality of line patterns are periodically arranged in a short direction at a pitch ‘dr’, for example.

When seen through in a direction perpendicular to a light-receiving surface LRS of the photoelectric conversion part 21r, the second diffraction grating 62r-1 to 62r-5 has a pattern obtained by shifting of the first diffraction grating 61r-1 to 61r-5. The shift amount and the shift direction are determined in advance according to the incident angle of light to be detected by the focus-detecting pixel FPr.

The second diffraction grating 62r-1 to 62r-5 can be formed as amplitude grating-type diffraction grating by patterning of a second wiring layer in the multilayer wiring structure 31r (e.g., into a plurality of line patterns). Note that, although not illustrated, a plurality of grooves corresponding to the second diffraction grating 62r-1 to 62r-5 can be formed in an upper surface of a second interlayer insulation film 35 in the multilayer wiring structure 31r, and a third interlayer insulation film 36 can be embedded in the plurality of grooves, thereby to form phase grating-type second diffraction grating 62r-1 to 62r-5.

A distance Zr between the first diffraction grating 61r-1 to 61r-5 and the second diffraction grating 62r-1 to 62r-5 in a direction perpendicular to the light-receiving surface LRS of the photoelectric conversion part 21r is expressed by the following numerical expression 2 where the peak wavelength of the spectral transmittance of the color filter 71r (that is, the red (R) peak wavelength) is λr.

Zr=(dr)²/(λr) Numerical Expression 2

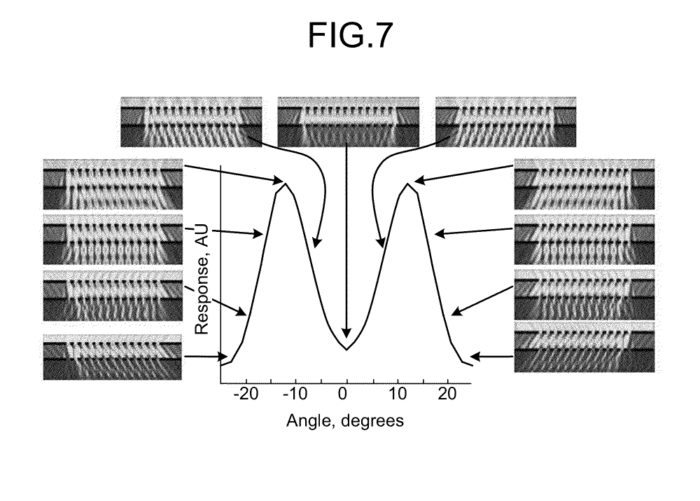

The distance Zr corresponds to Z_{T}/2 that is the half of the Talbot distance with respect to light in the red (R) wavelength region. This enables the first diffraction grating 61r-1 to 61r-5 to form a self-image near the second diffraction grating 62r-1 to 62r-5. Therefore, when light is incident with an incident angle near the incident angle of light to be detected, the quantity of light that passes through the second diffraction grating 62r-1 to 62r-5 in the angle detection structure 60r shows a maximum value (see FIG. 7). This enables the angle detection structure 60r to detect the incident angle of light.

The angle detection structure 60g has first diffraction grating 61g-1 to 61g-5 and second diffraction grating 62g-1 to 62g-5.

The first diffraction grating 61g-1 to 61g-5 is arranged above the photoelectric conversion part 21g. The first diffraction grating 61g-1 to 61g-5 is arranged between the photoelectric conversion part 21g and the color filter 71g, and is at least periodically arranged in a one-dimensional manner. For example, the first diffraction grating 61g-1 to 61g-5 has a plurality of line patterns, and the plurality of line patterns are periodically arranged in a one-dimensional manner (see FIG. 9). The plurality of line patterns are periodically arranged in a short direction at a pitch ‘dg’, for example.

A plurality of grooves corresponding to the first diffraction grating 61g-1 to 61g-5 are formed in an upper surface of an uppermost interlayer insulation film 32 in the multilayer wiring structure 31g, and a protection film 33 is embedded in the plurality of grooves, thereby to form the phase grating-type first diffraction grating 61g-1 to 61g-5. Note that, as illustrated in FIG. 5, the first diffraction grating 61g-1 to 61g-5 can be formed as amplitude grating-type diffraction grating by patterning of an uppermost wiring layer in the multilayer wiring structure 31g (e.g., into a plurality of line patterns).

The second diffraction grating 62g-1 to 62g-5 is arranged between the photoelectric conversion part 21g and the first diffraction grating 61g-1 to 61g-5. The second diffraction grating 62g-1 to 62g-5 has a pattern corresponding to the first diffraction grating 61g-1 to 61g-5. For example, the second diffraction grating 62g-1 to 62g-5 has a plurality of line patterns, and the plurality of line patterns are periodically arranged in a one-dimensional manner (see FIG. 9). The plurality of line patterns are periodically arranged in a short direction at a pitch ‘dg’, for example.

When seen through in a direction perpendicular to a light-receiving surface LRS of the photoelectric conversion part 21g, the second diffraction grating 62g-1 to 62g-5 has a pattern obtained by shifting of the first diffraction grating 61g-1 to 61g-5. The shift amount and the shift direction are determined in advance according to the incident angle of light to be detected in the focus-detecting pixel FPg.

The second diffraction grating 62g-1 to 62g-5 can be formed as amplitude grating-type diffraction grating by patterning of a second wiring layer in the multilayer wiring structure 31g (e.g., into a plurality of line patterns). Note that, although not illustrated, a plurality of grooves corresponding to the second diffraction grating 62g-1 to 62g-5 can be formed in an upper surface of a second interlayer insulation film 35 in the multilayer wiring structure 31g, and a third interlayer insulation film 36 can be embedded in the plurality of grooves, thereby to form phase grating-type second diffraction grating 62g-1 to 62g-5.

A distance Zg between the first diffraction grating 61g-1 to 61g-5 and the second diffraction grating 62g-1 to 62g-5 in a direction perpendicular to the light-receiving surface LRS of the photoelectric conversion part 21g is expressed by the following numerical expression 3 where the peak wavelength of the spectral transmittance of the color filter 71g (that is, the green (G) peak wavelength) is λg.

Zg=(dg)²/(λg) Numerical Expression 3

The distance Zg corresponds to Z_{T}/2 that is the half of the Talbot distance with respect to light in the green (G) wavelength region. This enables the first diffraction grating 61g-1 to 61g-5 to form a self-image near the second diffraction grating 62g-1 to 62g-5. Therefore, when light is incident with an incident angle near the incident angle of light to be detected, the quantity of light that passes through the second diffraction grating 62g-1 to 62g-5 in the angle detection structure 60g shows a maximum value (see FIG. 7). This enables the angle detection structure 60g to detect the incident angle of light.

The angle detection structure 60b has first diffraction grating 61b-1 to 61b-5 and second diffraction grating 62b-1 to 62b-5.

The first diffraction grating 61b-1 to 61b-5 is arranged above the photoelectric conversion part 21b. The first diffraction grating 61b-1 to 61b-5 is arranged between the photoelectric conversion part 21b and the color filter 71b, and is at least periodically arranged in a one-dimensional manner. For example, the first diffraction grating 61b-1 to 61b-5 has a plurality of line patterns, and the plurality of line patterns are periodically arranged in a one-dimensional manner (see FIG. 9). The plurality of line patterns are periodically arranged in a short direction at a pitch ‘db’, for example.

For example, a plurality of grooves corresponding to the first diffraction grating 61b-1 to 61b-5 are formed in an upper surface of an uppermost interlayer insulation film 32 in the multilayer wiring structure 31b, and a protection film 33 is embedded in the plurality of grooves, thereby to form the phase grating-type first diffraction grating 61b-1 to 61b-5. Note that, as illustrated in FIG. 5, the first diffraction grating 61b-1 to 61b-5 can be formed as amplitude grating-type diffraction grating by patterning of an uppermost wiring layer in the multilayer wiring structure 31b (into a plurality of line patterns, for example).

The second diffraction grating 62b-1 to 62b-5 is arranged between the photoelectric conversion part 21b and the first diffraction grating 61b-1 to 61b-5. The second diffraction grating 62b-1 to 62b-5 has a pattern corresponding to the first diffraction grating 61b-1 to 61b-5. For example, the second diffraction grating 62b-1 to 62b-5 has a plurality of line patterns, and the plurality of line patterns are periodically arranged in a one-dimensional manner (see FIG. 9). The plurality of line patterns are periodically arranged in a short direction at a pitch ‘db’, for example.

When seen through in a direction perpendicular to a light-receiving surface LRS of the photoelectric conversion part 21b, the second diffraction grating 62b-1 to 62b-5 has a pattern obtained by shifting of the first diffraction grating 61b-1 to 61b-5. The shift amount and the shift direction are determined in advance according to the incident angle of light to be detected in the focus-detecting pixel FPb.

The second diffraction grating 62b-1 to 62b-5 can be formed as amplitude grating-type diffraction grating by patterning of a lowermost wiring layer in the multilayer wiring structure 31b (e.g., into a plurality of line patterns). Note that, although not illustrated, a plurality of grooves corresponding to the second diffraction grating 62b-1 to 62b-5 can be formed in an upper surface of a lowermost interlayer insulation film 34 in the multilayer wiring structure 31b, and a second interlayer insulation film 35 can be embedded in the plurality of grooves, thereby to form phase grating-type second diffraction grating 62b-1 to 62b-5.

A distance Zb between the first diffraction grating 61b-1 to 61b-5 and the second diffraction grating 62b-1 to 62b-5 in a direction perpendicular to the light-receiving surface LRS of the photoelectric conversion part 21b is expressed by the following numerical expression 4 where the peak wavelength of the spectral transmittance of the color filter 71b (i.e., the blue (B) peak wavelength) is λb.

Zb=(db)²/(λb) Numerical Expression 4

The distance Zb corresponds to Z_{T}/2 that is the half of the Talbot distance with respect to the light in the blue (B) wavelength region. This enables the first diffraction grating 61b-1 to 61b-5 to form a self-image near the second diffraction grating 62b-1 to 62b-5. Therefore, when light is incident at an incident angle near the incident angle of light to be detected, the quantity of light that passes through the second diffraction grating 62b-1 to 62b-5 shows a maximum value in the angle detection structure 60b (see FIG. 7). This enables the angle detection structure 60b to detect the incident angle of light.

When comparing the focus-detecting pixels FPr, FPg, and FPb having different wavelength bands of light to be received, the array pitch ‘dr’ of the first diffraction grating 61r-1 to 61r-5 for red (R) is made larger than the array pitch ‘dg’ of the first diffraction grating 61g-1 to 61g-5 for green (G) according to the fact that the red (R) peak wavelength λr is longer than the green (G) peak wavelength λg. Accordingly, the configuration of Zr≈Zg as illustrated in FIG. 4 can be realized while the numerical expressions 2 and 3 are satisfied. The array pitch ‘db’ of the first diffraction grating 61b-1 to 61b-5 for blue (B) and the array pitch ‘dg’ of the first diffraction grating 61g-1 to 61g-5 for green (G) are adjusted according to the fact that the blue (B) peak wavelength λb is shorter than the green (G) peak wavelength λg. Accordingly, the configuration of Zb>Zg as illustrated in FIG. 4 can be realized.

Note that other embodiments can be employed in the focus-detecting pixels FPr, FPg, and FPb as long as the Talbot distances for red (R), green (G), and blue (B) are secured. For example, in the focus-detecting pixels FPr, FPg, and FPb, the Talbot distances for red (R), green (G), and blue (B) may be Zr≈Zg≈Zb while adjusting the array pitch of the grating. Alternatively, for example, in the focus-detecting pixels FPr, FPg, and FPb, the Talbot distances for red (R), green (G), and blue (B) may be Zr<Zg<Zb while equalizing the array pitch of the grating.

Further, the photoelectric conversion parts 21r, 21g, and 21b of the focus-detecting pixels FPr, FPg, and FPb are different from the photoelectric conversion parts 20r, 20g, and 20b of the imaging pixels IPr, IPg, and IPb in the following point. Widths W21r, W21g, and W21b of the photoelectric conversion parts 20r, 20g, and 20b are larger than widths W20r, W20g, and W20b of the photoelectric conversion parts 21r, 21g, and 21b in a direction along the light-receiving surface LRS of the photoelectric conversion parts 21r, 21g, and 21b. Therefore, each of the number of the first diffraction grating 61b-1 to 61b-5 and the number of the second diffraction grating 62b-1 to 62b-5 in the angle detection structures 60r, 60g, and 60b can be easily secured to the number necessary for securing the detection accuracy of the incident angle of light (e.g., four).

Further, the focus-detecting pixels FPr, FPg, and FPb do not include micro lenses 50r, 50g, and 50b like the imaging pixels IPr, IPg, and IPb. Therefore, the incident angle of light to the focus-detecting pixels FPr, FPg, and FPb and the incident angle of light to the angle detection structures 60r, 60g, and 60b can be easily equalized, whereby the detection accuracy of the incident angle of light by the angle detection structures 60r, 60g, and 60b can be easily secured.

Next, an AF operation according to the Talbot method will be described with reference to FIG. 2.

The storage unit 7 stores correspondence information 7a in the post-processing unit 3 of the camera system 1. The correspondence information 7a is information in which a position in the pixel array 12, an incident angle of light, and a defocusing amount are corresponding to each other with respect to a plurality of positions in the pixel array 12. The correspondence information 7a may be a table in which a position in the pixel array 12, an incident angle of light, and a defocusing amount are corresponding to each other with respect to a plurality of positions in the pixel array 12, for example. Alternatively, the correspondence information 7a may include a table in which a position in the pixel array 12 and an incident angle of light are corresponding to each other with respect to a plurality of positions in the pixel array 12, and a function with which a defocusing amount can be obtained from the position in the pixel array 12 and the incident angle of light. Further, the ISP 6 includes a detection unit 6a and an adjustment unit 6b.

The detection unit 6a receives output of the plurality of focus-detecting pixels in the solid-state imaging device 5. The detection unit 6a obtains the incident angles of light with respect to a plurality of positions in the pixel array 12 according to the output of the plurality of focus-detecting pixels, and detects a focus state of the photographing lens 47. For example, the detection unit 6a identifies a focus-detecting pixel that has received the quantity of light having a threshold value or more from among the plurality of focus-detecting pixels, and refers to the correspondence information 7a to obtain the incident angle of light detected by the identified focus-detecting pixel. That is, the detection unit 6a obtains the incident angles of light with respect to a plurality of positions in the pixel array. The detection unit 6a refers to the correspondence information 7a in the storage unit 7 regarding the incident angles of light and obtains a defocusing amount as the focus state of the photographing lens 47. That is, the detection unit 6a detects the focus state of the photographing lens 47. The detection unit 6a supplies the detected focus state of the photographing lens 47 to the adjustment unit 6b.

The adjustment unit 6b obtains focus adjustment information used for adjusting the photographing lens 47 in a focusing state (just focus) according to the focus state of the photographing lens 47. The adjustment unit 6b obtains a drive amount of the photographing lens 47b as the focus adjustment information, for example. The adjustment unit 6b controls the lens drive mechanism 47c based on the obtained focus adjustment information to adjust the photographing lenses 47a and 47b in the focusing state (just focus).

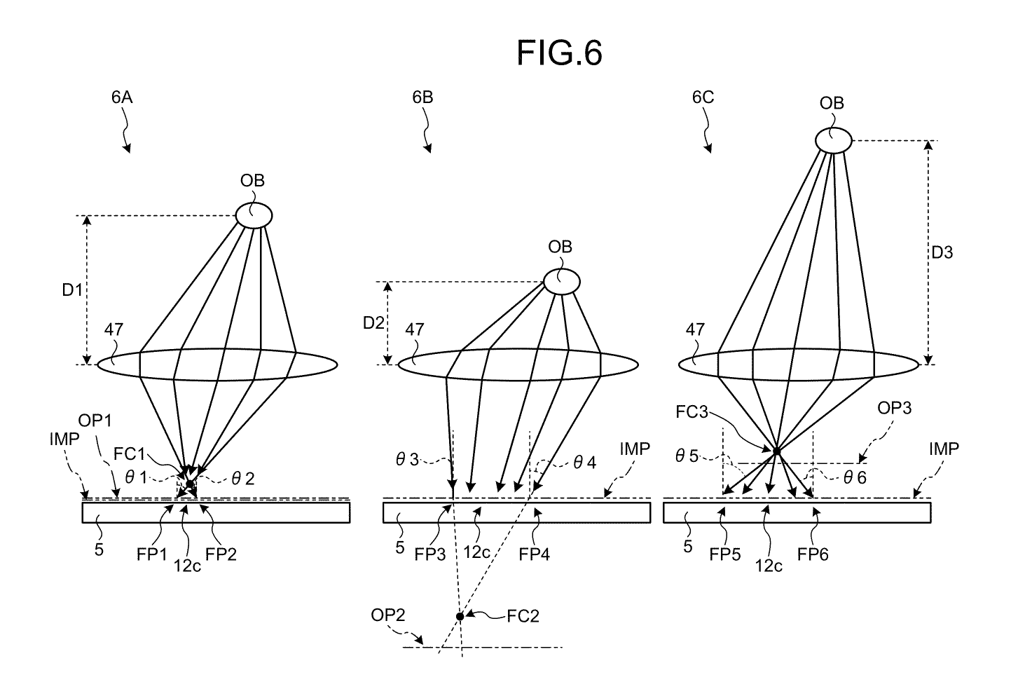

Next, relationships between the focus state of the photographing lens 47 and the incident angle of light to the solid-state imaging device 5 will be described with reference to FIG. 6. FIG. 6 is a diagram illustrating relationships between the focus state of the photographing lens 47 and the incident angle of light to the solid-state imaging device 5.

FIG. 6A illustrates a case in which the focus state of the photographing lens 47 is in a focusing state (just focus). That is, a distance D1 from the photographing lens 47 to an object OB approximately accords with an object distance scheduled for a current focus state of the photographing lens 47. Therefore, an image-reforming surface OP1 of the object image by the photographing lens 47 approximately accords with an imaging surface (pixel array 12) IMP of the solid-state imaging device 5. A focus position FC1 of the photographing lens 47 is a position near the imaging surface IMP between the photographing lens 47 and the imaging surface of the solid-state imaging device 5.

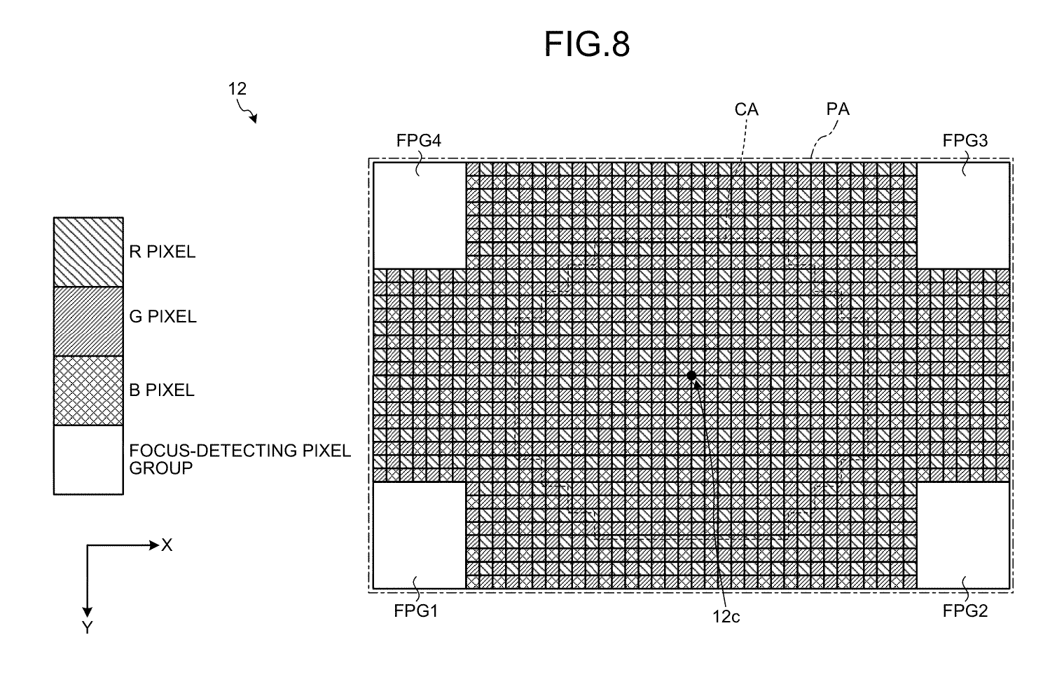

At this time, the incident angle of light to the pixel array 12 with respect to the imaging surface IMP is about 0° near a center 12c of the pixel array 12 (see FIG. 8) (i.e., an incident angle approximately perpendicular to the imaging surface IMP). The incident angle of light to the pixel array 12 with respect to the imaging surface IMP is an angle θ1 that is slightly inclined toward a right side from about 0° in a focus-detecting pixel FP1 on a left side of the center 12c of the pixel array 12 in FIG. 6A. The incident angle of light to the pixel array 12 with respect to the imaging surface IMP is an angle θ2 that is slightly inclined to a left side from about 0° in a focus-detecting pixel FP2 on a right side of the center 12c of the pixel array 12 in FIG. 6A.

For example, the detection unit 6a identifies the focus-detecting pixels FP1 and FP2 that have received the quantity of light having a threshold value or more from among the output of the plurality of focus-detecting pixels. That is, the detection unit 6a obtains the incident angles θ1 and θ2 of light with respect to a plurality of positions in the pixel array 12. The detection unit 6a refers to the correspondence information 7a in the storage unit 7 regarding the obtained incident angles θ1 and θ2 of light, and obtains a defocusing amount (≈0) as the focus state of the photographing lens 47. That is, the detection unit 6a detects that the focus state of the photographing lens 47 is the focusing state (just focus). The detection unit 6a supplies the detected focus state of the photographing lens 47 to the adjustment unit 6b.

The adjustment unit 6b obtains focus adjustment information used for adjusting the photographing lens 47 to the focusing state (just focus) according to the fact that the focus state of the photographing lens 47 is the focusing state (just focus). The adjustment unit 6b obtains a drive amount (≈0) of the photographing lens 47b as the focus adjustment information. The adjustment unit 6b maintains the photographing lens 47a and 47b in the focusing state (just focus) without operating the lens drive mechanism 47c based on the obtained focus adjustment information.

FIG. 6B illustrates a case in which the focus state of the photographing lens 47 is a rear-focus state. That is, a distance D2 from the photographing lens 47 to the object OB is shorter than an object distance scheduled for a current focus state of the photographing lens 47, and therefore, an image-reforming surface OP2 of the object image by the photographing lens 47 is positioned farther than the imaging surface (pixel array 12) IMP of the solid-state imaging device 5. A focus position FC2 of the photographing lens 47 is often positioned farther than the imaging surface of the solid-state imaging device 5.

At this time, the incident angle of light to the pixel array 12 with respect to the imaging surface IMP is about 0° near the center 12c of the pixel array 12. The incident angle of light to the pixel array 12 with respect to the imaging surface IMP is an angle θ3 that is slightly inclined toward a left side from about 0° in a focus-detecting pixel FP3 on the left side of the center 12c of the pixel array 12 in FIG. 6B. The incident angle of light to the pixel array 12 with respect to the imaging surface IMP is an angle θ4 that is slightly inclined toward a right side from about 0° in a focus-detecting pixel FP4 on the right side of the center 12c of the pixel array 12 in FIG. 6B.

For example, the detection unit 6a identifies the focus-detecting pixels FP3 and FP4 that have received the quantity of light having a threshold value or more from among the output of the plurality of focus-detecting pixels. That is, the detection unit 6a obtains the incident angles θ3 and θ4 with respect to a plurality of positions in the pixel array 12. The detection unit 6a refers to the correspondence information 7a in the storage unit 7 regarding the obtained incident angles θ3 and θ4 of light, and obtains a defocusing amount (=k(D2−D1), k is a proportionality factor) as the focus state of the photographing lens 47. That is, the detection unit 6a detects that the focus state of the photographing lens 47 is a rear-focus state of the defocusing amount k(D2−D1). The detection unit 6a supplies the detected focus state of the photographing lens 47 to the adjustment unit 6b.

The adjustment unit 6b obtains the focus adjustment information used for adjusting the photographing lens 47 to the focusing state (just focus) according to the focus state of the photographing lens 47. The adjustment unit 6b obtains, as the focus adjustment information, a drive amount of the photographing lens 47b so that the focus state of the photographing lens 47b becomes a focus state where an object distance scheduled for the focus state is the distance D2. The adjustment unit 6b controls the lens drive mechanism 47c based on the obtained focus adjustment information, and adjusts the photographing lens 47a and 47b in the focusing state (just focus).

FIG. 6C illustrates a case in which the focus state of the photographing lens 47 is a front-focus state. That is, a distance D3 from the photographing lens 47 to the object OB is positioned longer than an object distance scheduled for a current focus state of the photographing lens 47. Therefore, an image-reforming surface OP3 of the object image by the photographing lens 47 is positioned closer than the imaging surface (pixel array 12) IMP of the solid-state imaging device 5. A focus position FC3 of the photographing lens 47 is closer than the imaging surface of the solid-state imaging device 5.

At this time, the incident angle of light to the pixel array 12 with respect to the imaging surface IMP is about 0° near the center 12c of the pixel array 12. The incident angle of light to the pixel array 12 with respect to the imaging surface IMP is an angle θ5 that is substantially inclined toward a right side from about 0° in a focus-detecting pixel FP5 on the left side of the center 12c of the pixel array 12 in FIG. 6C. The incident angle of light to the pixel array 12 with respect to the imaging surface IMP is an angle θ6 that is substantially inclined toward a left side from about 0° in a focus-detecting pixel FP6 on a right side of the center 12c of the pixel array 12 in FIG. 6C.

For example, the detection unit 6a identifies the focus-detecting pixels FP5 and FP6 that have received the quantity of light having a threshold value or more from among the output of the plurality of focus-detecting pixels. That is, the detection unit 6a obtains the incident angles of θ5 and θ6 with respect to a plurality of positions in the pixel array 12. The detection unit 6a refers to the correspondence information 7a in the storage unit 7 regarding the obtained incident angles θ5 and θ6 of light, and obtains a defocusing amount (=k(D3−D1)) as the focus state of the photographing lens 47. That is, the detection unit 6a detects that the focus state of the photographing lens 47 is a front-focus state of the defocusing amount k(D3−D1). The detection unit 6a supplies the detected focus state of the photographing lens 47 to the adjustment unit 6b.

The adjustment unit 6b obtains the focus adjustment information used for adjusting the photographing lens 47 to the focusing state (just focus) according to the focus state of the photographing lens 47. The adjustment unit 6b obtains, as the focus adjustment information, a drive amount of the photographing lens 47b so that the focus state of the photographing lens 47 becomes a focus state where an object distance scheduled for the focus state is the distance D3. The adjustment unit 6b controls the lens drive mechanism 47c based on the obtained focus adjustment information to adjust the photographing lenses 47a and 47b in the focusing state (just focus).

In this way, by obtaining the incident angle of light with respect to a plurality of positions in the pixel array 12, a focus state of the photographing lens 47 is detected and can be adjusted to be a focusing state.

Next, an operation of a focus-detecting pixel will be described with reference to FIG. 7. FIG. 7 is a diagram illustrating an operation of a focus-detecting pixel.

FIG. 7 exemplarily illustrates a characteristic of a case in which the shift amount of the second diffraction grating 62g-1 to 62g-5 with respect to the first diffraction grating 61g-1 to 61g-5 is zero in the angle detection structure 60g of the focus-detecting pixel FPg. In this case, in FIG. 7, as the incident angle of light to the focus-detecting pixel FPg, an angle inclined by 10° toward the right side from about 0° in 6A to FIG. 6C (i.e., an incident angle approximately perpendicular to the imaging surface) is indicated by +10°, and an angle inclined by 10° toward the left side from about 0° in 6A to FIG. 6C is indicated by −10°.

As illustrated in FIG. 7, in the angle detection structure 60g of the focus-detecting pixel FPg, the incident angle of light shows peaks of the light transmission characteristic near +10° and near −10°. That is, the angle detection structure 60g of the focus-detecting pixel FPg can detect two values near +10° and near −10° as the incident angle of light. This enables the angle detection structure 60g of the focus-detecting pixel FPg to accurately detect the deviation of the incident angle of light from the focusing state (just focus).

In addition, the angle detection structure 60g can detect the two values of angles. Therefore, when preparing a pixel for focusing state (just focus) detection, a pixel for rear-focus state detection, and a pixel for front-focus state detection as the focus-detecting pixel FPg, the number of pixels to be prepared can be reduced (for example, by half) with respect to the number of candidate angles to be detected.

Next, a layout configuration of the pixel array 12 will be described with reference to FIGS. 8 and 9. FIG. 8 is a diagram illustrating a layout configuration of the pixel array 12. FIG. 9 is a diagram especially illustrating a configuration of a focus-detecting pixel group.

In the solid-state imaging device 5, an image of an object is formed on the pixel array 12 by the photographing lens 47 of a camera. At this time, to image the image of the object in color, it is necessary to selectively photoelectrically convert light in the wavelength region of the three primary colors (red (R), green (G), and blue (B)) from among the incident light. Therefore, a color filter is provided according to a Bayer array in each imaging pixel, for example. In FIG. 8, the imaging pixels IPr, IPg, and IPb corresponding to red (R), green (G), and blue (B) are respectively illustrated as an R pixel, a G pixel, and a B pixel.

The pixel array 12 is divided into a region near the center 12c of the pixel array 12 and a peripheral region thereof. For example, the pixel array 12 is divided into a central region CA including the center 12c of the pixel array 12, which is indicated as a region inside the broken line in FIG. 8, and a peripheral region PA indicated as a region outside the broken line in FIG. 8.

In the pixel array 12, in each of the central region CA and the peripheral region PA, a layout configuration in which the imaging pixels IPr, IPg, and IPb are repeatedly arrayed according to the Bayer array is regarded as a basic structure, and for example, parts of the imaging pixels IPr, IPg, and IPb in the peripheral region PA are replaced with the focus-detecting pixel groups FPG1 to FPG4 in the basic structure.

The focus-detecting pixel groups FPG1 to FPG4 are, for example, arranged near end portions in the peripheral region PA (for example, near corner portions). This enables the focus-detecting pixels to realize the AF function with almost no effect on the image quality of the imaging pixels IPr, IPg, and IPb.

Each of the focus-detecting pixel groups FPG1 to FPG4 includes the number of focus-detecting pixels FPr, FPg, and FPb corresponding to the number of candidate angles to be detected. The number of candidate angles to be detected is determined according to a desired maximum corresponding angle and a desired angle interval.

For example, the focus-detecting pixel group FPG1 includes, as illustrated in FIG. 9, a plurality of sub pixel groups SFPG (1, 1) to SFPG (j, k) for detecting a plurality of different angles. Each of the sub pixel groups SFPG (1, 1) to SFPG (j, k) includes four focus-detecting pixels in which a color filter corresponding to an array unit in the Bayer array is provided. In each of the sub pixel groups SFPG (1, 1) to SFPG (j, k), for example, the angle detection structures of the four focus-detecting pixels detect approximately equal incident angles. That is, in each sub pixel group, in the focus-detecting pixel, the shift amount of the second diffraction grating with respect to the light-receiving surface when seen through in a direction perpendicular to the photoelectric conversion part is changed.

For example, as illustrated in FIG. 9, in each focus-detecting pixel, the first diffraction grating include a plurality of first line patterns LP11 to LP14 respectively extending in an Y direction, and the second diffraction grating include a plurality of second line patterns LP21 to LP24. The plurality of second line patterns LP21 to LP24 correspond to the plurality of first line patterns LP11 to LP14, and are a pattern obtained by shifting of the plurality of first line patterns LP11 to LP14 by the shift amount corresponding to an angle φX, for example.

For example, the plurality of sub pixel groups SFPG (1, 1) to SFPG (j, k) change a component of the incident angle to be detected in an X direction for each column. In the focus-detecting pixel, the shift amount of the plurality of second line patterns LP21 to LP24 in the X direction with respect to the plurality of first line patterns LP11 to LP14 is changed between the shift amounts corresponding to angles φX1 to φXk for each column of the sub pixel group. The angle φX (φX1 to φXk) is an angle formed by a normal line of the light-receiving surface of the photoelectric conversion part and a line connecting the line pattern LP13 and a corresponding portion of the line pattern LP23 (e.g., an edge portion on the right side). That is, the shift amount in the X direction when the plurality of first line patterns LP11 to LP14 are shifted in a short direction (X direction) and the plurality of second line patterns LP21 to LP24 are formed is changed for each column of the sub pixel group.

For example, the plurality of sub pixel groups SFPG (1, 1) to SFPG (j, k) change the component of the incident angle to be detected in the Y direction for each row. That is, in the focus-detecting pixel for each row of the sub pixel group, the shift amounts of the plurality of first line patterns LP11 to LP14 and the plurality of second line patterns LP21 to LP24 in the Y direction are changed between the shift amounts corresponding to the angles φY1 to φYj. The angle φY (φY1 to φYj) is a rotation angle that rotates the line pattern LP13 and the line pattern LP23 clockwise based on a position extending in the Y direction when seen through in a direction perpendicular to the light-receiving surface of the photoelectric conversion part. That is, the plurality of first line patterns LP11 to LP14 and the plurality of second line patterns LP21 to LP24 in a longitudinal direction are mutually shifted in a rotation direction by the shift amounts respectively corresponding to the angle φY (φY1 to φYj) for each row of the sub pixel group.

For example, a center sub pixel group SFPG (j/2, k/2) among the plurality of sub pixel groups SFPG (1, 1) to SFPG (j, k) may be configured to detect the incident angle corresponding to the focusing state (just focus) in the pixel position. At this time, a sub pixel group (for example, a sub pixel group SFPG (1, k)) at a side closer to the pixel center 12c (see FIG. 8) than the sub pixel group SFPG (j/2, k/2) can detect the incident angle corresponding to the front-focus state or the rear-focus state, or a sub pixel group (for example, sub pixel group SFPG(j, 1)) at a side farther from the pixel center 12c (see FIG. 8) than the sub pixel group SFPG(j/2, k/2) can detect the incident angle corresponding to the rear-focus state or the front-focus state.

Note that, the component in the Y direction may be changed for each column of the sub pixel group by assuming that the plurality of first and second line patterns respectively extend in the X direction and shifting the plurality of first and second line patterns into the rotation direction based on the positions extending in the X direction.

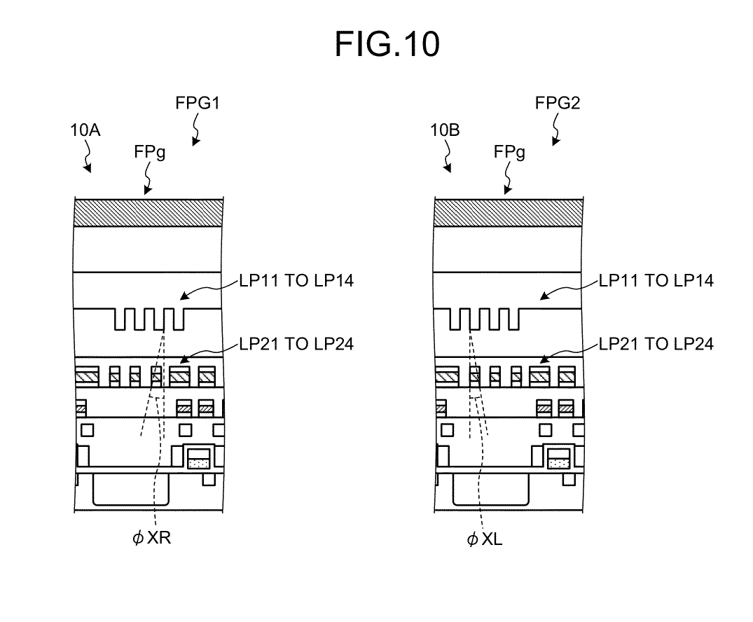

Further, the configurations of other focus-detecting pixel groups FPG2 to FPG4 are basically similar to the focus-detecting pixel group FPG1. However, as illustrated in 10A and 10B of FIG. 10, when the groups are arranged on opposite sides to each other with respect to the center of the pixel array, the shift directions may be different. 10A and 10B of FIG. 10 are diagrams illustrating cross-section configurations of two focus-detecting pixels arranged on opposite sides to each other with respect to the center of the pixel array.

The focus-detecting pixel group FPG1 and the focus-detecting pixel group FPG2 are arranged on opposite sides to each other with respect to the center 12c of the pixel array 12 when seen in the X direction (see FIG. 8). Thus, when seen in the X direction, the shift direction of the second diffraction grating with respect to the first diffraction grating corresponding to each of the focus-detecting pixels of the focus-detecting pixel group FPG1 is different from the shift direction of the second diffraction grating with respect to the first diffraction grating corresponding to each of the focus-detecting pixels of the focus-detecting pixel group FPG2.

For example, as illustrated in 10A of FIG. 10, in the focus-detecting pixel FPg of the focus-detecting pixel group FPG1, the shift amount of the plurality of second line patterns LP21 to LP24 with respect to the plurality of first line patterns LP11 to LP14 corresponds to an angle φXR inclined toward the right direction of 10A of FIG. 10 with respect to about 0°. For example, as illustrated in 10B of FIG. 10, in the focus-detecting pixel FPg of the focus-detecting pixel group FPG2, the shift amount of the plurality of second line patterns LP21 to LP24 with respect to the plurality of first line patterns LP11 to LP14 corresponds to an angle φXL inclined toward the left direction of 10B of FIG. 10 with respect to about 0°.

Alternatively, the focus-detecting pixel group FPG1 and the focus-detecting pixel group FPG4 are arranged on opposite sides to each other with respect to the center 12c of the pixel array 12 when seen in the Y direction (see FIG. 8). Thus, when seen in the Y direction, the shift direction of the second diffraction grating with respect to the first diffraction grating corresponding to each of the focus-detecting pixels of the focus-detecting pixel group FPG1 is different from the shift direction of the second diffraction grating with respect to the first diffraction grating corresponding to each of the focus-detecting pixels of the focus-detecting pixel group FPG4.

As described above, in the embodiment, the focus-detecting pixels FPr, FPg, and FPb include the first diffraction grating and the second diffraction grating in the solid-state imaging device 5. The first diffraction grating is arranged above the photoelectric conversion part. The second diffraction grating is arranged between the photoelectric conversion part and the first diffraction grating. The distance between the first diffraction grating and the second diffraction grating in the direction perpendicular to the light-receiving surface of the photoelectric conversion part can be, for example, an integer multiple of the half of the Talbot distance (an even-number multiple or an odd-number multiple). This enables the first diffraction grating to form an image according to a self-image near the second diffraction grating. Therefore, in the angle detection structures 60r, 60g, and 60b of the focus-detecting pixels FPr, FPg, and FPb, the quantity of light that passes through the second diffraction grating indicates a maximum value when light is incident with an incident angle near the incident angle of light to be detected. This enables the angle detection structures 60r, 60g, and 60b to detect the incident angle of light.

Therefore, the defocusing amount of the photographing lens 47 can be accurately detected through the incident angle of light to the focus-detecting pixels FPr, FPg, and FPb with the angle detection structures 60r, 60g, and 60b of the focus-detecting pixels FPr, FPg, and FPb. That is, a signal for the AF operation can be obtained in the solid-state imaging device 5, and imaging and the AF function can be realized by one chip without using a line sensor exclusively for the AF operation. Therefore, the camera system 1 to which the solid-state imaging device 5 is applied can be easily downsized.

Further, by obtaining a corresponding defocusing amount from the incident angle of light and driving the photographing lens 47 to a just focus position, focus correction can be performed. Accordingly, the focus correction can be performed with simple processing, and the photographing lens 47 can be driven while reciprocating drive of the photographing lens 47 is suppressed. Therefore, a high-speed AF operation can be realized.

That is, according to the embodiment, the solid-state imaging device 5 that easily enables downsizing of the camera system 1 and realizes the high-speed AF operation can be provided.

Further, in the embodiment, the focus-detecting pixels FPr, FPg, and FPb do not include micro lenses in the solid-state imaging device 5. This enables the incident angle of light to the focus-detecting pixels FPr, FPg, and FPb and the incident angle of light to the angle detection structures 60r, 60g, and 60b to be easily equalized, whereby the detection accuracy of the incident angle of light by the angle detection structures 60r, 60g, and 60b can be easily secured.

Further, in the embodiment, the widths of the photoelectric conversion parts 21r, 21g, and 21b of the focus-detecting pixels FPr, FPg, and FPb are larger than the widths of the photoelectric conversion parts 20r, 20g, and 20b of the imaging pixels IPr, IPg, and IPb in the solid-state imaging device 5. For example, in the direction along the light-receiving surface LRS of the photoelectric conversion parts 21r, 21g, and 21b, the widths W21r, W21g, and W21b of the photoelectric conversion parts 21r, 21g, and 21b are larger than the widths W20r, W20g, and W20b of the photoelectric conversion parts 20r, 20g, and 20b. Accordingly, each of the number of the first diffraction grating 61b-1 to 61b-5 and the number of the second diffraction grating 62b-1 to 62b-5 in the angle detection structures 60r, 60g, and 60b can be easily secured to the number of grating (for example, four) necessary for securing the detection accuracy of the incident angle of light.

Further, in the embodiment, the second diffraction grating has a pattern corresponding to the first diffraction grating in the focus-detecting pixels FPr, FPg, and FPb of the solid-state imaging device 5. For example, when seen through in a direction perpendicular to the light-receiving surface of the photoelectric conversion part, the second diffraction grating has a pattern obtained by shifting of the first diffraction grating according to the incident angle of light to be detected in the focus-detecting pixels FPr, FPg, and FPb. Accordingly, an angle corresponding to the just focus and angles around the angle can be easily prepared as the incident angle of light to be detected in the focus-detecting pixels FPr, FPg, and FPb, whereby a signal necessary for detecting the focusing state of the photographing lens 47 can be output from the solid-state imaging device 5.

Further, in the embodiment, in the pixel array 12 of the solid-state imaging device 5, the shift direction of the second diffraction grating with respect to the first diffraction grating corresponding to one focus-detecting pixel from among the plurality of focus-detecting pixels is different from the shift direction of the second diffraction grating with respect to the first diffraction grating corresponding to a focus-detecting pixel arranged on an opposite side to the one focus-detecting pixel with respect to the center 12c of the pixel array 12. This enables each of the plurality of focus-detecting pixels in the pixel array 12 to be configured to detect a suitable incident angle according to an arranged position of the each pixel.

Further, in the embodiment, the first diffraction grating includes a plurality of first line patterns. The second diffraction grating includes a plurality of second line patterns corresponding to the plurality of first line patterns in the focus-detecting pixels FPr, FPg, and FPb of the solid-state imaging device 5. For example, when seen through in a direction perpendicular to the light-receiving surface of the photoelectric conversion part, the plurality of second line patterns include a pattern obtained by shifting of the plurality of first line patterns according to the incident light of light to be detected in the focus-detecting pixels. The plurality of first line patterns form a self-image near the plurality of second line patterns. Accordingly, a structure for detecting the incident angle of light can be realized with a simple configuration.

Further, in the embodiment, when seen through in a direction perpendicular to the light-receiving surface of the photoelectric conversion part, the plurality of second line patterns have a pattern obtained by shifting of the plurality of first line patterns in a short direction in the focus-detecting pixels FPr, FPg, and FPb of the solid-state imaging device 5. Accordingly, a structure for detecting a plurality of incident angles that is different from each other and serves as a candidate of an angle to be detected can be realized with a simple configuration.

Further, in the embodiment, when seen through in a direction perpendicular to the light-receiving surface of the photoelectric conversion part, the plurality of focus-detecting pixels have the plurality of first line patterns and the plurality of second line patterns mutually shifted in the rotation direction. Accordingly, a structure for detecting a plurality of incident angles that is different from each other and serves as a candidate of an angle to be detected can be realized with a simple configuration.

Further, in the embodiment, the focus-detecting pixels FPr, FPg, and FPb are arranged in the peripheral region PA in the pixel array 12 of the solid-state imaging device 5. This enables the focus-detecting pixels FPr, FPg, and FPb to realize the AF function with almost no effect on the image quality of the imaging pixels IPr, IPg, and IPb.

Further, in the embodiment, the plurality of focus-detecting pixels FPr, FPg, and FPb of the solid-state imaging device 5 output signals for detecting a focusing state of the photographing lens 47 in the camera system 1. The detection unit 6a obtains the incident angle of light with respect to a plurality of positions in the pixel array 12 according to the output of the plurality of focus-detecting pixels FPr, FPg, and FPb, and detects the focus state of the photographing lens 47. The adjustment unit 6b adjusts the photographing lens 47 to be in the focusing state (just focus) according to the focus state of the photographing lens 47. Accordingly, the focus correction can be performed with simple processing and the photographing lens 47 can be driven while reciprocating drive of the photographing lens 47 is suppressed, whereby a high-speed AF operation can be realized.

Note that, in the embodiment, a case has been exemplarily described, in which the solid-state imaging device 5 receives the wavelengths of three colors (RGB) in visible light. However, the solid-state imaging device 5 may receive wavelengths in the infrared region or in the ultraviolet region other than the visible light. For example, in the focus-detecting pixel, the distance between the first diffraction grating and the second diffraction grating may be set to the Talbot distance for a center wavelength of infrared light. In this case, the AF function with excellent accuracy in the dark can be realized when the camera system 1 is used for a security camera.

Alternatively, the solid-state imaging device 5 may be used for a single color according to the use, and an angle detection structure for single color may be formed. For example, in the focus-detecting pixel, the color filter is omitted and the distance between the first diffraction grating and the second diffraction grating may be set to the Talbot distance for a center wavelength of white light. Alternatively, for example, any of the angle detection structures of the focus-detecting pixels FPr, FPg, and FPb for red, green, and blue illustrated in FIG. 4 may be used as the angle detection structure for single color.

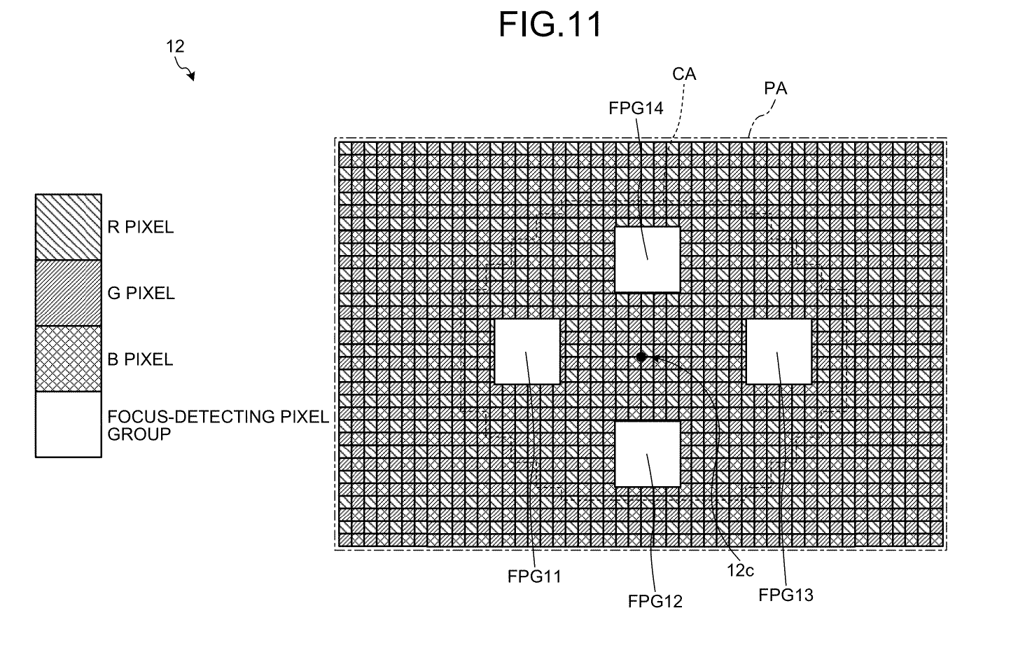

Alternatively, in the pixel array 12 of the solid-state imaging device 5, the focus-detecting pixels may be arranged in the central region CA in place of the peripheral region PA. FIG. 11 is a diagram illustrating a layout configuration of a pixel array 12 in a modification. For example, as illustrated in FIG. 11, in a central region CA and in a peripheral region PA in the pixel array 12, a layout configuration in which the imaging pixels IPr, IPg, and IPb are repeatedly arrayed according to a Bayer array is regarded as a basic structure, and for example, parts of imaging pixels IPr, IPg, and IPb in the central region CA are replaced with focus-detecting pixel groups FPG11 to FPG14 in the basic structure. The focus-detecting pixel groups FPG11 to FPG14 are arranged to surround a center 12c of the pixel array 12, for example. This enables the focus-detecting pixels to realize the AF function with almost no effect on the image quality of the imaging pixels IPr, IPg, and IPb.

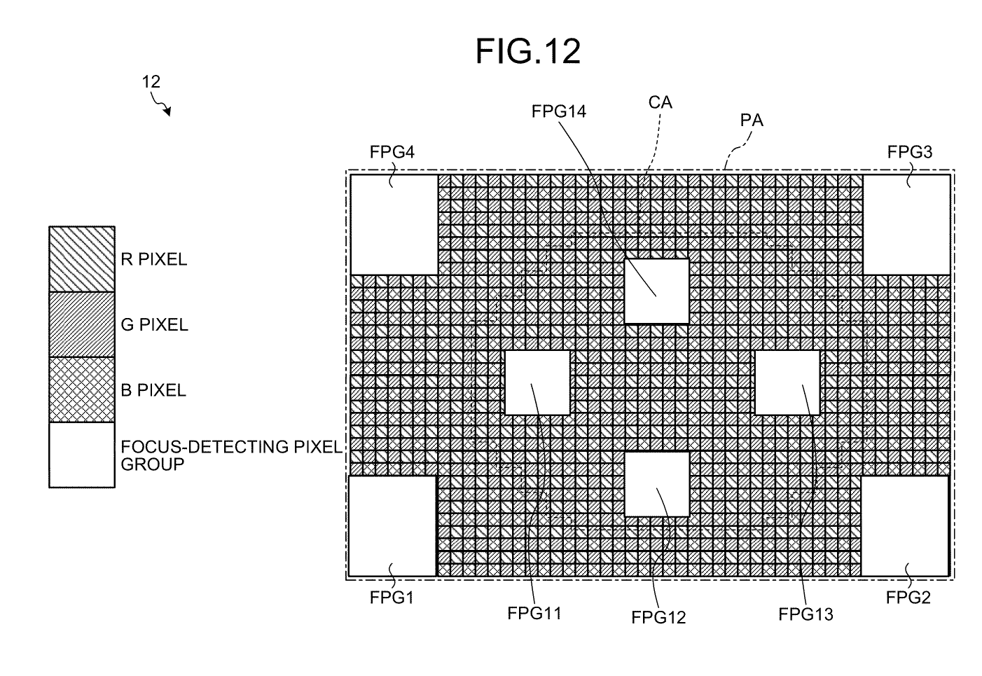

Alternatively, in the pixel array 12 of the solid-state imaging device 5, the focus-detecting pixels may be arranged in the central region CA in addition to the peripheral region PA. FIG. 12 is a diagram illustrating a layout configuration of a pixel array 12 in another modification. For example, as illustrated in FIG. 12, in a central region CA and in a peripheral region PA in the pixel array 12, a layout configuration in which the imaging pixels IPr, IPg, and IPb are repeatedly arrayed according to a Bayer array is regarded as a basic structure, and for example, parts of imaging pixels IPr, IPg, and IPb in the central region CA and in the peripheral region PA are replaced with focus-detecting pixel groups FPG1 to FPG4 and FPG11 to FPG14 in the basic structure. The focus-detecting pixel groups FPG1 to FPG4 are arranged near end portions in the peripheral region PA (for example, near corner portions), for example. The focus-detecting pixel groups FPG11 to FPG14 are arranged to surround a center 12c of the pixel array 12, for example. Accordingly, the detection accuracy of angles by the plurality of focus-detecting pixels can be improved as the whole pixel array 12.

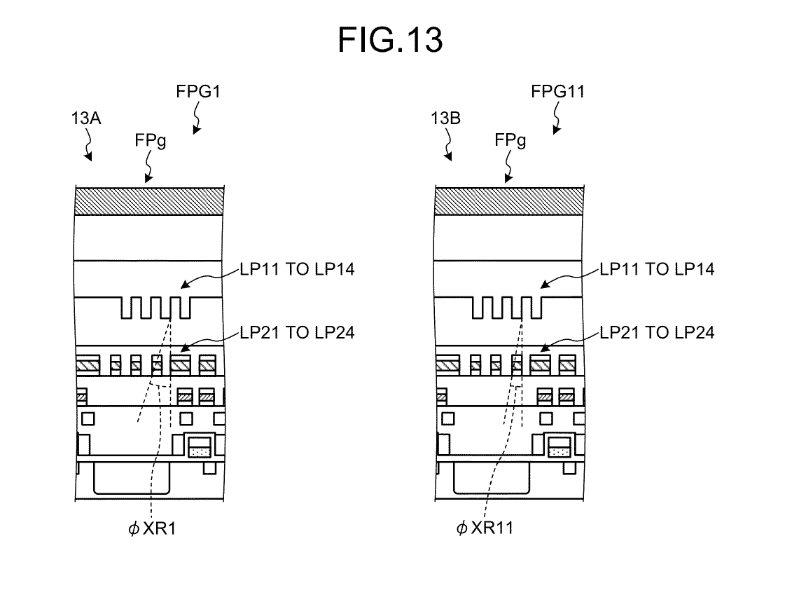

At this time, while configurations of the focus-detecting pixel groups FPG1 to FPG4 arranged in the peripheral region PA are basically similar to the configurations of the focus-detecting pixel groups FPG11 to FPG14 arranged in the central region CA, shift amounts may be different from each other. FIG. 13 is a diagram illustrating cross-section configurations of two focus-detecting pixels respectively arranged in a central region and in a peripheral region of a pixel array.

Since a focus-detecting pixel group FPG1 and a focus-detecting pixel group FPG11 are respectively arranged in the central region CA and in the peripheral region PA, the incident angles of light to be detected are different from each other (see FIG. 6). With this, when seen in the X direction, a shift amount of a second diffraction grating with respect to a first diffraction grating corresponding to a focus-detecting pixel of the focus-detecting pixel group FPG1 is different from a shift amount of a second diffraction grating with respect to a first diffraction grating corresponding to a focus-detecting pixel of the focus-detecting pixel group FPG11.

For example, as illustrated in 13A of FIG. 13, in a focus-detecting pixel FPg of the focus-detecting pixel group FPG1, a shift amount of a plurality of second line patterns LP21 to LP24 with respect to a plurality of first line patterns LP11 to LP14 corresponds to an angle φXR1 inclined toward a right direction of FIG. 13 with respect to about 0°. For example, as illustrated in 13B of FIG. 13, in a focus-detecting pixel FPg of the focus-detecting pixel group FPG11, a shift amount of a plurality of second line patterns LP21 to LP24 with respect to a plurality of first line patterns LP11 to LP14 corresponds to an angle φXR11 (<φXR1) inclined toward a right direction of FIG. 13 with respect to about 0°.

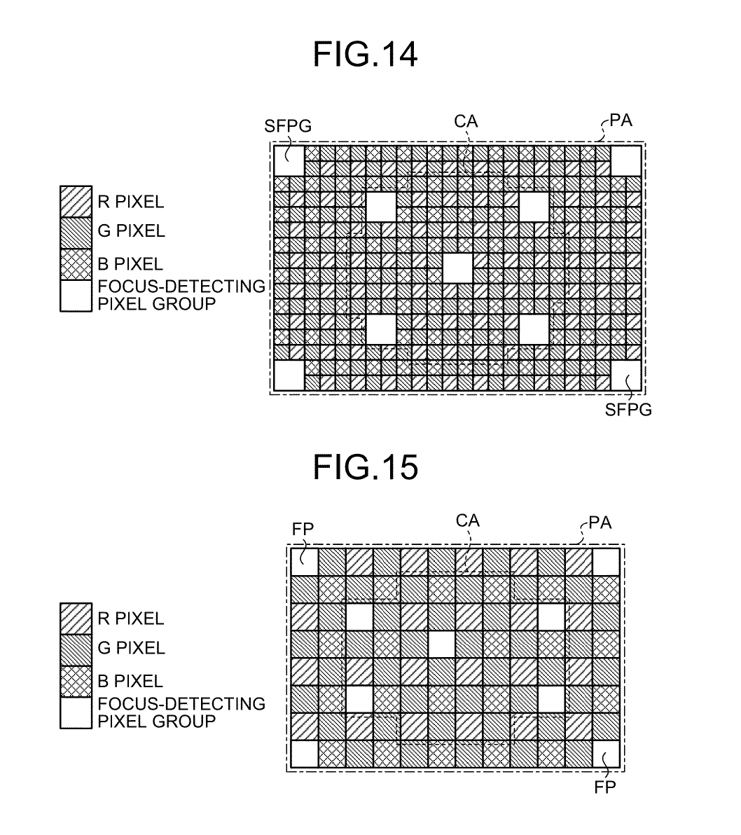

Alternatively, in the embodiment, a case in which the plurality of focus-detecting pixels in the focus-detecting pixel groups FPG1 to FPG4 are collectively arranged has been exemplarily described. However, the plurality of focus-detecting pixels in the focus-detecting pixel groups FPG1 to FPG4 may be periodically or non-periodically arrayed at intervals. FIGS. 14 and 15 are diagrams illustrating layout configurations of a pixel array 12 in other modifications.

For example, as illustrated in FIG. 14, the plurality of focus-detecting pixels may be arrayed at intervals in units of sub pixel group SFPG corresponding to an array unit of a Bayer array. That is, by setting the number of focus-detecting pixels to be collectively arranged to four, for example, an effect on the image quality by the imaging pixels IPr, IPg, and IPb can be suppressed and the number of arranging points in the pixel array 12 can be easily increased. Accordingly, the image quality of an image imaged by the imaging pixels IPr, IPg, and IPb can be improved and the detection accuracy of angles by the focus-detecting pixels can be improved.

Alternatively, for example, as illustrated in FIG. 15, the number of focus-detecting pixels may be arrayed at intervals in units of one focus-detecting pixel FP. That is, by setting the number of focus-detecting pixels to be collectively arranged to one, for example, an effect on the image quality by the imaging pixels IPr, IPg, and IPb can be further suppressed and the number of arranging points in the pixel array 12 can be easily increased. Accordingly, the image quality of an image imaged by the imaging pixels IPr, IPg, and IPb can be further improved and the detection accuracy of angles by the focus-detecting pixel can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array in which a plurality of pixels are arrayed;
wherein the plurality of pixels include an imaging pixel and a focus-detecting pixel, and
the focus-detecting pixel includes
a first photoelectric conversion part,
a first diffraction grating arranged above the first photoelectric conversion part, and
a second diffraction grating arranged between the first photoelectric conversion part and the first diffraction grating.

2. The solid-state imaging device according to claim 1, wherein
the imaging pixel includes
a second photoelectric conversion part, and
a micro lens arranged above the second photoelectric conversion part, and
the focus-detecting pixel does not include a micro lens.

3. The solid-state imaging device according to claim 2, wherein
a width of the first photoelectric conversion part in a direction along a light-receiving surface of the first photoelectric conversion part is larger than a width of the second photoelectric conversion part in the direction along the light-receiving surface of the first photoelectric conversion part.

4. The solid-state imaging device according to claim 1, wherein
the second diffraction grating includes a pattern corresponding to the first diffraction grating.

5. The solid-state imaging device according to claim 4, wherein
the first diffraction grating forms an image according to a self-image near the second diffraction grating.

6. The solid-state imaging device according to claim 4, wherein,
when seen through in a direction perpendicular to a light-receiving surface of the first photoelectric conversion part, the second diffraction grating includes a pattern obtained by shifting of the first diffraction grating.

7. The solid-state imaging device according to claim 6, wherein
the second diffraction grating includes a pattern obtained by shifting of the first diffraction grating according to an incident angle of light to be detected by the focus-detecting pixel.

8. The solid-state imaging device according to claim 7, wherein
the first diffraction grating and the second diffraction grating are arranged in plural respectively,
the pixel array includes a plurality of the focus-detecting pixels provided corresponding to the first diffraction grating and the second diffraction grating, and
a shift direction of the second diffraction grating with respect to the first diffraction grating corresponding to one focus-detecting pixel from among the plurality of focus-detecting pixels is different from a shift direction of the second diffraction grating with respect to the first diffraction grating corresponding to the other focus-detecting pixels arranged on an opposite side to the one focus-detecting pixel with respect to a center of the pixel array.

9. The solid-state imaging device according to claim 1, wherein
the first diffraction grating includes a plurality of first line patterns, and
the second diffraction grating includes a plurality of second line patterns corresponding to the plurality of first line patterns.

10. The solid-state imaging device according to claim 9, wherein,
when seen through in a direction perpendicular to a light-receiving surface of the first photoelectric conversion part, the second line patterns include a plurality of patterns obtained by shifting of the first line patterns in a short direction.

11. The solid-state imaging device according to claim 9, wherein
the first diffraction grating and the second diffraction grating are arranged in plural respectively, and
when seen through in a direction perpendicular to a light-receiving surface of the first photoelectric conversion part, the first diffraction grating and the second diffraction grating include the plurality of first line patterns and the plurality of second line patterns mutually shifted in a rotation direction.

12. The solid-state imaging device according to claim 1, wherein
the focus-detecting pixel is arranged in a peripheral region in the pixel array.

13. The solid-state imaging device according to claim 1, wherein
the focus-detecting pixel is arranged in a central region in the pixel array.

14. The solid-state imaging device according to claim 1, wherein
the plurality of pixels include a first focus-detecting pixel and a second focus-detecting pixel,
the first focus-detecting pixel is arranged in a central region in the pixel array, and
the second focus-detecting pixel is arranged in a peripheral region in the pixel array.

15. The solid-state imaging device according to claim 14, wherein,
when seen through in a direction perpendicular to a light-receiving surface of the first photoelectric conversion part, the second diffraction grating includes a pattern obtained by shifting of the first diffraction grating in each of the first focus-detecting pixel and the second focus-detecting pixel, and
a shift amount of the second diffraction grating with respect to the first diffraction grating corresponding to the first focus-detecting pixel is different from a shift amount of the second diffraction grating with respect to the first diffraction grating corresponding to the second focus-detecting pixel.

16. An imaging system comprising:
a photographing lens; and
a solid-state imaging device including a pixel array in which a plurality of pixels are arrayed, the plurality of pixels including a plurality of imaging pixels and a plurality of focus-detecting pixels that output a signal to detect a focusing state of the photographing lens, each of the plurality of focus-detecting pixels including a first photoelectric conversion part, a first diffraction grating, and a second diffraction grating, the first diffraction grating being arranged above the first photoelectric conversion part, the second diffraction grating being arranged between the first photoelectric conversion part and the first diffraction grating; and
a detection unit configured to obtain an incident angle of light with respect to a plurality of positions in the pixel array according to an output of the plurality of focus-detecting pixels, and to detect the focusing state of the photographing lens.

17. The imaging system according to claim 16, wherein
each of the plurality of imaging pixels includes
a second photoelectric conversion part, and
a micro lens arranged above the second photoelectric conversion part, and
each of the plurality of the focus-detecting pixels does not include a micro lens.

18. The imaging system according to claim 16, wherein
the second diffraction grating includes a pattern corresponding to the first diffraction grating.

19. The imaging system according to claim 18, wherein,
when seen through in a direction perpendicular to a light-receiving surface of the first photoelectric conversion part, the second diffraction grating includes a pattern obtained by shifting of the first diffraction grating according to an incident angle of light to be detected by the focus-detecting pixel.

20. The imaging system according to claim 16, wherein
the first diffraction grating includes a plurality of first line patterns, and
the second diffraction grating includes a plurality of second line patterns corresponding to the plurality of first line patterns.
